(19) United States
(12) Patent Application Publication
(10) Pub. No.: US 2026/0349199 A1
(43) Pub. Date: Nov. 5, 2026

(54) PLUGGABLE OPTICAL ENGINE PACKAGING STRUCTURE

(71) Applicant: SHUNYUN TECHNOLOGY (ZHONGSHAN) Limited, Zhongshan (CN)

(72) Inventors: Guangsheng He, Zhongshan (CN); TeFu Tseng, Zhongshan (CN); Jie Huang, Zhongshan (CN); Mark Ming Seng Tieu, Zhongshan (CN); Quan Jiang, Zhongshan (CN)

(21) Appl. No.: 19/463,027

(22) Filed: Jan. 28, 2026

(30) Foreign Application Priority Data
Apr. 30, 2025 (CN) 202510561940.6

(51) Int. Cl. G02B 6/42

(52) U.S. Cl. CPC G02B 6/4249; G02B 6/423; G02B 6/4243

(57) ABSTRACT

A pluggable optical engine packaging structure including a substrate, a silicon photonics chip, a fiber array unit, and a top cover. The silicon photonics chip is provided with a first coupling portion and a positioning seat provided with an optical through hole. The fiber array unit includes a fiber array and a fixing structure. A bottom side of the fixing structure is provided with a second coupling portion optically communicating with the fiber array. The top cover is provided with an insertion hole. The fixing structure is guided and inserted into the insertion hole. The positioning seat is provided with a first alignment structure and a second alignment structure. The second alignment structure and the first alignment structure are in a positioning fit within a radial plane of the optical through hole, and the second coupling portion is in vertical alignment with the first coupling portion.

### CROSS-REFERENCE TO RELATED APPLICATION

The present disclosure claims the benefit of Chinese patent application No. 202510561940.6, filed on Apr. 30, 2025, which is incorporated herein by reference in its entirety.

### TECHNICAL FIELD

The present disclosure relates to the technical field of optical engines, and in particular to a pluggable optical engine packaging structure.

### BACKGROUND

With the development of large-scale data centers and artificial intelligence (AI) compute clusters, co-packaged optics (CPO) plays a significant role in improving the data transmission rate. As a core component of the CPO, a silicon photonics chip is primarily used for converting optical and electrical signals, and for transmitting the optical signal via coupling to a fiber array.

For example, the Chinese Utility Model Patent No. CN 217689527 U granted on Oct. 28, 2022, discloses an optical fiber connector and an optical chip connection device. The optical chip connection device includes a silicon photonic integrated chip and the optical fiber connector. The optical fiber connector includes an upper glass cover plate, a middle glass cover plate, a lower glass cover plate, and a fiber array. The upper glass cover plate is connected to the middle glass cover plate. The middle glass cover plate is connected to the lower glass cover plate in a staggered manner. The middle glass cover plate is provided with V-shaped grooves. The fiber array is fixedly connected into the V-shaped grooves via the upper and middle glass cover plates. A step surface is provided between the middle glass cover plate and the lower glass cover plate. The optical fiber connector is connected to an optical chip via the step surface. An optical signal undergoes total internal reflection when propagating to a beveled surface. The beveled surface redirects the optical signal by 90 degrees, enabling stable propagation of the optical signal within the fiber array.

The optical chip connection device in the prior art connects to the optical chip via the step surface of the optical fiber connector, typically employing a fixed connection form, which fails to meet a requirement for flexible plugging and unplugging of the fiber array. Moreover, the optical fiber connector lacks precise positioning within a plane of the optical chip, making it impossible to ensure high-precision coupling between the fiber array and waveguides of the optical chip.

### SUMMARY

A technical problem to be solved by the present disclosure is that existing optical chip connection devices employ a fixed connection form using a step surface, which fails to meet a requirement for flexible plugging and unplugging of a fiber array. Furthermore, optical fiber connectors lack precise positioning within planes of optical chips, making it impossible to ensure high-precision coupling between the fiber array and waveguides of the optical chips.

To solve the above technical problem, the present disclosure provides technical solutions for a pluggable optical engine packaging structure.

A pluggable optical engine packaging structure includes a substrate, a silicon photonics chip, a fiber array unit, and a top cover, where the silicon photonics chip is disposed at a top side of the substrate, and the substrate is electrically connected to the silicon photonics chip;
a top side of the silicon photonics chip is provided with a first coupling portion and a positioning seat; the positioning seat is provided with an optical through hole that vertically penetrates through the positioning seat; and the optical through hole corresponds to the first coupling portion;
the fiber array unit includes a fiber array and a fixing structure; the fixing structure is fixedly connected to the fiber array; a bottom side of the fixing structure is provided with a second coupling portion; and the second coupling portion optically communicates with the fiber array;
the top cover is disposed at the top side of the substrate; the top cover is provided with an insertion hole corresponding to the positioning seat; the insertion hole is coaxially arranged with the optical through hole; and the fixing structure is guided and inserted into the insertion hole;
a top side of the positioning seat is provided with a first alignment structure, the bottom side of the fixing structure is provided with a second alignment structure; the second alignment structure is in a positioning fit with the first alignment structure within a radial plane of the optical through hole; and the second coupling portion is in vertical alignment with the first coupling portion; and
an elastic restricting member is provided inside the insertion hole; the elastic restricting member has a locked state and an unlocked state; an outer side of the fixing structure is provided with an engaging portion, and in the locked state, the elastic restricting member is in a retaining fit with the engaging portion along an axial direction of the optical through hole.

Further, the top cover is provided with a fixing hole. A guide sleeve is provided in the fixing hole. The guide sleeve is provided with an inner hole and a tapered countersink hole sequentially arranged along the axial direction of the optical through hole. The tapered countersink hole is located on a side of the inner hole away from the positioning seat. The inner hole and the tapered countersink hole are connected to form the insertion hole.

Further, a side wall of the guide sleeve parallel to a width direction of the fiber array is provided with a horizontal hole. The elastic restricting member is disposed in the horizontal hole. The elastic restricting member includes a glass ball and a spring. The glass ball is movably disposed in the horizontal hole. The spring is disposed in the horizontal hole, and the spring is in an elastic pressing fit with the glass ball. The engaging portion is designed as an engaging groove. The engaging groove extends parallel to the width direction of the fiber array, and the engaging groove is in a concave-convex fit with the glass ball.

Further, two elastic restricting members are symmetrically provided about the insertion hole. Two engaging portions are symmetrically provided about the fixing structure. A resultant force exerted by the two elastic restricting members on the fixing structure is zero.

Further, the first alignment structure is a protrusion structure, and the second alignment structure is a groove structure; or the first alignment structure is a groove structure, and the second alignment structure is a protrusion structure.

Further, the first alignment structure includes transverse ribs and longitudinal ribs. The transverse ribs extend parallel to the width direction of the fiber array. The longitudinal ribs are respectively arranged perpendicular to the transverse ribs within the radial plane of the optical through hole.

The second alignment structure includes transverse grooves and longitudinal grooves. The transverse grooves extend parallel to the width direction of the fiber array. The longitudinal grooves are respectively perpendicular to the transverse grooves within the radial plane of the optical through hole.

The transverse ribs are in the concave-convex fit with the transverse grooves, and the longitudinal ribs are in the concave-convex fit with the longitudinal grooves.

Further, the optical through hole has first long sides and first short sides. The first long sides extend along the width direction of the fiber array. The first short sides are respectively arranged perpendicular to the first long sides. There are two transverse ribs and two longitudinal ribs. The two transverse ribs are respectively disposed at outer sides of the first long sides of the optical through hole. The two longitudinal ribs are respectively disposed at outer sides of the first short sides of the optical through hole.

The second coupling portion has second long sides and second short sides. The second long sides extend along the width direction of the fiber array. The second short sides are respectively arranged perpendicular to the second long sides. There are two transverse grooves and two longitudinal grooves. The two transverse grooves are respectively disposed at outer sides of the second long sides of the second coupling portion. The two longitudinal grooves are respectively disposed at outer sides of the second short sides of the second coupling portion.

Further, the transverse ribs are respectively spaced apart from the longitudinal ribs, and the transverse grooves respectively intersect with the longitudinal grooves.

Further, the transverse ribs and the longitudinal ribs each have an arc-shaped cross-sectional profile, and the transverse grooves and the longitudinal grooves each have a V-shaped cross-sectional profile.

Further, the optical through hole includes a first hole segment and a second hole segment sequentially provided along the axial direction of the optical through hole. The second hole segment is located on a side of the first hole segment away from the silicon photonics chip. A cross-sectional width of the first hole segment is less than a cross-sectional width of the second hole segment. The second coupling portion is in an accommodating fit with the second hole segment.

The pluggable optical engine packaging structure provided by the present disclosure has following beneficial effects over the prior art: the pluggable optical engine packaging structure includes the substrate, the silicon photonics chip, the fiber array unit, and the top cover; the silicon photonics chip is disposed at the top side of the substrate, the silicon photonics chip is electrically connected to the substrate, the top side of the silicon photonics chip is provided with the first coupling portion and the positioning seat, the optical through hole of the positioning seat corresponds to the first coupling portion, the top cover is disposed at the top side of the substrate, the top cover is provided with the insertion hole corresponding to the positioning seat, the insertion hole is coaxially arranged with the optical through hole, and the fixing structure of the fiber array unit is guided and inserted into the insertion hole.

The top cover provides a physical protection for the silicon photonics chip and the fiber array unit. By reasonably arranging the positioning seat, the optical through hole, and the fiber array unit, the optical engine packaging structure is more compact, reducing a size of an optical engine and meeting requirements for miniaturization and integration. Since the fiber array unit is disposed in a guided and inserted manner, it may be inserted into and pulled out of the packaging structure when maintenance or upgrade of the optical engine or replacement of the fiber array unit is required, enhancing maintainability and flexibility of the packaging structure.

The bottom side of the fixing structure is provided with the second coupling portion. The second coupling portion optically communicates with the fiber array. The top side of the positioning seat is provided with the first alignment structure, and the bottom side of the fixing structure is provided with the second alignment structure. Through the first coupling portion disposed on the silicon photonics chip and the second coupling portion of the fixing structure, and with the positioning fit between the first alignment structure of the positioning seat and the second alignment structure of the fixing structure within the radial plane of the optical through hole, the second coupling portion is in vertical alignment with the first coupling portion.

The alignment design enables high-precision optical coupling between the fiber array and waveguides of the silicon photonics chip, enhancing a transmission efficiency of optical signals, reducing optical loss, and ensuring a high-performance operation of the optical engine. The optical through hole corresponds to the first coupling portion, and the second coupling portion optically communicates with the fiber array. This ensures that an optical signal transmission path between the first coupling portion and the second coupling portion is located within an enclosed space of the optical through hole, reducing potential interference and loss of the optical signal.

Additionally, the elastic restricting member is provided in the insertion hole of the top cover. The elastic restricting member has the locked state and the unlocked state. The outer side of the fixing structure is provided with the engaging portion. In the locked state, the elastic restricting member is in the retaining fit with the engaging portion along the axial direction of the optical through hole, and in combination with the positioning fit between the first alignment structure and the second alignment structure within the radial plane of the optical through hole, precise multi-dimensional positioning of the fiber array unit may be achieved. The elastic restricting member in the locked state may prevent displacement or loosening of the fixing structure caused by factors such as vibration and an external force, ensuring stability and reliability of an optical coupling. Applying an upward pulling force to adjust the elastic restricting member to the unlocked state allows for smooth disassembly of the fixing structure and the fiber array, meeting the requirement for flexible plugging and unplugging of the fiber array unit.

It should be noted that when the elastic restricting member is in the retaining fit with the engaging portion, the first alignment structure and the second alignment structure simultaneously form the positioning fit relationship. Through a cooperative design of axial direction retaining and plane positioning, a coupling precision between the fiber array unit and the silicon photonics chip is thereby ensured.

### BRIEF DESCRIPTION OF THE DRAWINGS

FIG. 1 is a schematic perspective view of a pluggable optical engine packaging structure according to an embodiment of the present disclosure;

FIG. 2 is a schematic assembly view of an electrical chip, a silicon photonics chip, a positioning seat, a guide sleeve, and a fiber array unit according to an embodiment of the present disclosure;

FIG. 3 is a schematic assembly view of an electrical chip, a silicon photonics chip, and a positioning seat according to an embodiment of the present disclosure;

FIG. 4 is a schematic perspective view of a fiber array unit (from another perspective) according to an embodiment of the present disclosure;

FIG. 5 is a partial cross-sectional view of the pluggable optical engine packaging structure in FIG. 1.

In the figures: 1: substrate, 2: silicon photonics chip, 21: first coupling portion, 22: positioning seat, 23: optical through hole, 231: first long side, 232: first short side, 233: first hole segment, 234: second hole segment, 24: first alignment structure, 24a: transverse rib, 24b: longitudinal rib, 3: fiber array unit, 31: fiber array, 32: fixing structure, 320: engaging portion, 320a: engaging groove, 33: second alignment structure, 33a: transverse groove, 33b: longitudinal groove, 34: second coupling portion, 341: second long side, 342: second short side, 4: top cover, 40: insertion hole, 41: elastic restricting member, 411: glass ball, 412: spring, 42: fixing hole, 43: guide sleeve, 431: inner hole, 432: tapered countersink hole, 433: horizontal hole, 5: electrical chip, 6: application-specific integrated circuit (ASIC) chip, X: axial direction, and Y: width direction.

### DETAILED DESCRIPTION

The specific implementations of the present disclosure are described in more detail below with reference to the accompanying drawings and embodiments. The following embodiments are intended to illustrate the present disclosure, but not to limit the scope of the present disclosure.

It should be understood that, in the description of the present disclosure, the terms such as "central", "longitudinal", "transverse", "length", "width", "thickness", "upper", "lower", "front", "back", "left", "right", "vertical", "horizontal", "top", "bottom", "inner", "outer", "clockwise", and "counterclockwise" are intended to indicate orientation or position relationships based on those shown in the accompanying drawings. These terms are merely intended to facilitate the description of the present disclosure or simplify the description, rather than to indicate or imply that the mentioned apparatus or elements must have the specific orientation or be constructed and operated in the specific orientation. Therefore, these terms may not be construed as a limitation to the present disclosure.

In addition, the terms "first" and "second" are merely intended for a purpose of description, and shall not be understood as an indication or implication of relative importance or an implicit indication of a quantity of indicated technical features. Thus, features defined with "first" and "second" may explicitly or implicitly include one or more of the features. In the description of the present disclosure, "a plurality of" means two or more, unless otherwise specifically defined.

In the present disclosure, unless otherwise expressly specified and limited, the terms such as "dispose", "connected to", "connected with", and "fixed" should be comprehended in a broad sense. For example, it may be a fixed connection, a detachable connection, or an integral connection; it may be a direct connection, or an indirect connection through an intermediate medium; or it may be an internal communication between two elements or an interaction relationship between two elements. Those of ordinary skill in the art may understand specific meanings of the above terms in the present disclosure based on a specific situation.

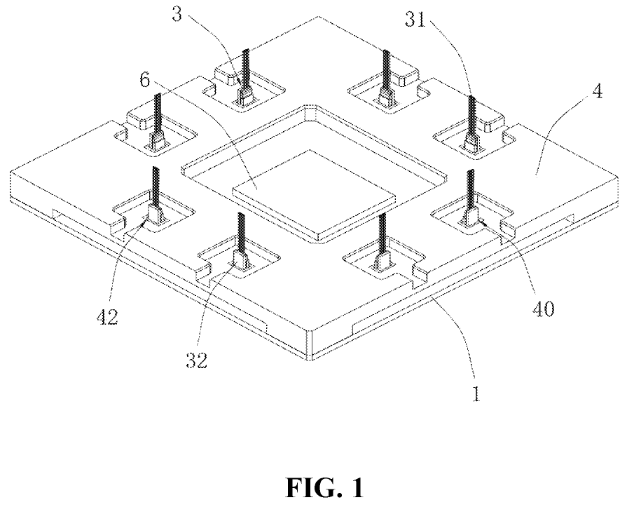

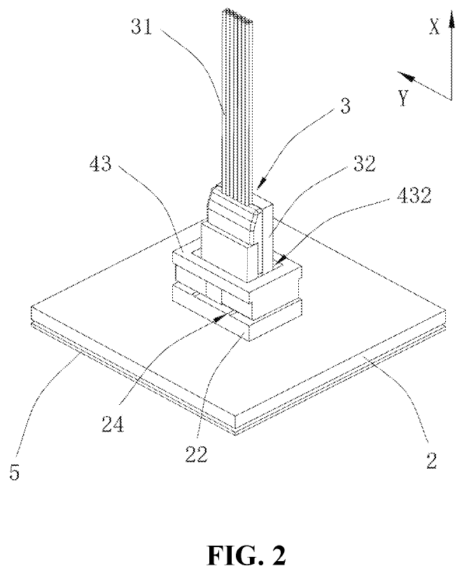

As shown in FIGS. 1-5, an embodiment of the present disclosure provides a pluggable optical engine packaging structure. The optical engine packaging structure includes a substrate 1, a silicon photonics chip 2, a fiber array unit 3, and a top cover 4. The silicon photonics chip 2 is disposed at a top side of the substrate 1, and the substrate 1 is electrically connected to the silicon photonics chip 2. A top side of the silicon photonics chip 2 is provided with a first coupling portion 21 and a positioning seat 22. The positioning seat 22 is provided with an optical through hole 23 vertically penetrating therethrough. The optical through hole 23 corresponds to the first coupling portion 21.

The fiber array unit 3 includes a fiber array 31 and a fixing structure 32. The fixing structure 32 is fixedly connected to the fiber array 31. A bottom side of the fixing structure 32 is provided with a second coupling portion 34. The second coupling portion 34 optically communicates with the fiber array 31. The top cover 4 is disposed at the top side of the substrate 1. The top cover 4 is provided with an insertion hole 40 corresponding to the positioning seat 22. The insertion hole 40 is coaxially arranged with the optical through hole 23. The fixing structure 32 is guided and inserted into the insertion hole 40, i.e., the fixing structure 32 is inserted into the insertion hole 40 and is slidable only along an insertion direction within the insertion hole 40.

A top side of the positioning seat 22 is provided with a first alignment structure 24. The bottom side of the fixing structure 32 is provided with a second alignment structure 33. The second alignment structure 33 is in a positioning fit with the first alignment structure 24 within a radial plane of the optical through hole 23. Herein, the positioning fit means that there is no relative displacement between the second alignment structure 33 and the first alignment structure 24 within the radial plane of the optical through hole 23. The second coupling portion 34 is in vertical alignment with the first coupling portion 21. Herein, the vertical alignment means that a geometric center of the second coupling portion 34 and a geometric center of the first coupling portion 21 are located on a same vertically extending straight line. An elastic restricting member 41 is further provided inside the insertion hole 40. The elastic restricting member 41 has a locked state and an unlocked state. An outer side of the fixing structure 32 is provided with an engaging portion 320. In the locked state, the elastic restricting member 41 is in a retaining fit with the engaging portion 320 along an axial direction X of the optical through hole 23, i.e., the elastic restricting member 41 retains or restricts the engaging portion 320.

The pluggable optical engine packaging structure includes the substrate 1, the silicon photonics chip 2, the fiber array unit 3, and the top cover 4. The silicon photonics chip 2 is disposed at the top side of the substrate 1. The silicon photonics chip 2 is electrically connected to the substrate 1. The top side of the silicon photonics chip 2 is provided with the first coupling portion 21 and the positioning seat 22. The optical through hole 23 of the positioning seat 22 corresponds to the first coupling portion 21. The top cover 4 is disposed at the top side of the substrate 1. The top cover 4 is provided with the insertion hole 40 corresponding to the positioning seat 22. The insertion hole 40 is coaxially arranged with the optical through hole 23. The fixing structure 32 of the fiber array unit 3 is guided and inserted into the insertion hole 40.

The top cover 4 provides a physical protection for the silicon photonics chip 2 and the fiber array unit 3. By reasonably arranging the positioning seat 22, the optical through hole 23, and the fiber array unit 3, the optical engine packaging structure is more compact, reducing a size of an optical engine and meeting requirements for miniaturization and integration. Since the fiber array unit 3 is disposed in a guided and inserted manner, it may be inserted into and pulled out of the packaging structure when maintenance or upgrade of the optical engine or replacement of the fiber array unit 3 is required, enhancing maintainability and flexibility of the packaging structure.

The bottom side of the fixing structure 32 is provided with the second coupling portion 34. The second coupling portion 34 optically communicates with the fiber array 31. The top side of the positioning seat 22 is provided with the first alignment structure 24, and the bottom side of the fixing structure 32 is provided with the second alignment structure 33. Through the first coupling portion 21 disposed on the silicon photonics chip 2 and the second coupling portion 34 of the fixing structure 32, and with the positioning fit between the first alignment structure 24 of the positioning seat 22 and the second alignment structure 33 of the fixing structure 32 within the radial plane of the optical through hole 23, the second coupling portion 34 is in vertical alignment with the first coupling portion 21.

This alignment design enables high-precision optical coupling between the fiber array 31 and waveguides of the silicon photonics chip 2, enhancing a transmission efficiency of optical signals, reducing optical loss, and ensuring a high-performance operation of the optical engine. The optical through hole 23 corresponds to the first coupling portion 21, and the second coupling portion 34 optically communicates with the fiber array 31. This ensures that an optical signal transmission path between the first coupling portion 21 and the second coupling portion 34 is located within an enclosed space of the optical through hole 23, reducing potential interference and loss of the optical signal.

Additionally, the elastic restricting member 41 is provided in the insertion hole 40 of the top cover 4. The elastic restricting member 41 has the locked state and the unlocked state. The outer side of the fixing structure 32 is provided with the engaging portion 320. In the locked state, the elastic restricting member 41 is in the retaining fit with the engaging portion 320 along the axial direction X of the optical through hole 23, and in combination with the positioning fit between the first alignment structure 24 and the second alignment structure 33 within the radial plane of the optical through hole 23, precise multi-dimensional positioning of the fiber array unit 3 may be achieved. The elastic restricting member 41 in the locked state may prevent displacement or loosening of the fixing structure 32 caused by factors such as vibration and an external force, ensuring stability and reliability of the optical coupling. Applying an upward pulling force to adjust the elastic restricting member 41 to the unlocked state allows for smooth disassembly of the fixing structure 32 and the fiber array 31, meeting a requirement for flexible plugging and unplugging of the fiber array unit 3, herein, adjusting the elastic restricting member 41 to the unlocked state means that the elastic restricting member 41 is separated from the engaging portion 320, and the retaining or restricting effect of the elastic restricting member 41 on the engaging portion 320 disappears.

It should be noted that when the elastic restricting member 41 is in the retaining fit with the engaging portion 320, the first alignment structure 24 and the second alignment structure 33 simultaneously form the positioning fit relationship. Through a cooperative design of axial direction retaining and plane positioning (the plane being perpendicular to the axial direction), a coupling precision between the fiber array unit 3 and the silicon photonics chip 2 is thereby ensured.

In the present embodiment, the top cover 4 is provided with a fixing hole 42. A guide sleeve 43 is provided in the fixing hole 42. The guide sleeve 43 is provided with an inner hole 431 and a tapered countersink hole 432 sequentially arranged along the axial direction X of the optical through hole 23. The tapered countersink hole 432 is located on a side of the inner hole 431 away from the positioning seat 22. The inner hole 431 and the tapered countersink hole 432 are connected to form the insertion hole 40. During an insertion process of the fixing structure 32, the tapered countersink hole 432 provides accurate guidance for the fixing structure 32, and ensures that the fixing structure 32 smoothly enters the inner hole 431 of the guide sleeve 43, thereby reducing a difficulty of aligning and inserting the fiber array unit 3 relative to the insertion hole 40.

Further, a side wall of the guide sleeve 43 parallel to a width direction Y of the fiber array 31 is provided with a horizontal hole 433. The elastic restricting member 41 is disposed in the horizontal hole 433. The elastic restricting member 41 includes a glass ball 411 and a spring 412. The glass ball 411 is movably disposed in the horizontal hole 433. The spring 412 is disposed in the horizontal hole 433 and is in an elastic pressing fit with the glass ball 411. Herein, the pressing fit means that there is a mutual acting force between the spring 412 and the glass ball 411 along an axial direction of the horizontal hole 433. The engaging portion 320 is designed as an engaging groove 320a. The engaging groove 320a extends along a direction parallel to the width direction Y of the fiber array 31, and the engaging groove 320a is in a concave-convex fit with the glass ball 411. Herein, the concave-convex fit means that an inner contour of the engaging groove 320a and an outer contour of the glass ball 411 have a complementary relationship.

During the insertion process of the fixing structure 32, the fixing structure 32 and a spherical surface of the glass ball 411 mutually press against each other. When forced, the spherical surface may convert an insertion force into a horizontal component force driving the glass ball 411 away from the inner hole 431, while simultaneously compressing the spring 412. According to the principle of force composition and resolution, when the spherical surface is forced, it is equivalent to being subjected to a tangential component force and a normal component force at a point where the spherical surface is forced. The tangential component force causes the glass ball 411 to roll, while the normal component force is further resolved into a horizontal component force and a vertical pressure. The vertical pressure is counteracted by a reaction force from the horizontal hole 433. Therefore, only the horizontal component force effectively drives a movement of the glass ball 411. When the engaging groove 320a aligns with the horizontal hole 433, the spring 412 presses back against the glass ball 411, causing the glass ball 411 to move towards the inner hole 431 until the glass ball 411 snaps into the engaging groove 320a, providing axial positioning and ensuring an axial position accuracy of the fixing structure 32 within the insertion hole 40. When an upward pulling force is applied to extract the fixing structure 32, a horizontal component force driving the glass ball 411 away from the inner hole 431 is similarly generated. The horizontal component force during pulling is greater than an elastic force of the spring 412, thereby overcoming retaining effect and allowing for smooth extraction and disassembly.

As a further preferred solution, two elastic restricting members 41 are symmetrically provided about an axis of the insertion hole 40. Two engaging portions 320 are symmetrically provided about the fixing structure 32. A resultant force exerted by the two elastic restricting members 41 on the fixing structure 32 is zero.

Specifically, there are two scenarios: First, the two elastic restricting members 41 exert two opposing elastic forces on the fixing structure 32. Directions of the two elastic forces are opposite along a same straight line and equal in magnitude, i.e., the resultant force is zero, thereby avoiding a generation of a biased load or torque on the fixing structure 32. Second, neither of the two elastic restricting members 41 exerts an elastic force on the fixing structure 32, i.e., the resultant force is zero. The elastic restricting members 41 only provide axial direction retention for the fixing structure 32 when the fixing structure 32 is being pulled out. This not only ensures reliability of an inserted connection of the fiber array unit 3 but also avoids any impact on a coupling precision of the fiber array 31 due to biased loads or torques generated by the elastic restricting members 41.

The first alignment structure 24 is a protrusion structure, and the second alignment structure 33 is a groove structure. Specifically, the first alignment structure 24 includes transverse ribs 24a and longitudinal ribs 24b. The transverse ribs 24a extend parallel to the width direction Y of the fiber array 31. The longitudinal ribs 24b are arranged respectively perpendicular to the transverse ribs 24a within the radial plane of the optical through hole 23. The second alignment structure 33 includes transverse grooves 33a and longitudinal grooves 33b. The transverse grooves 33a extend along the direction parallel to the width direction Y of the fiber array 31. The longitudinal grooves 33b are arranged respectively perpendicular to the transverse grooves 33a within the radial plane of the optical through hole 23. The transverse ribs 24a are in the concave-convex fit with the transverse grooves 33a. The longitudinal ribs 24b are in the concave-convex fit with the longitudinal grooves 33b.

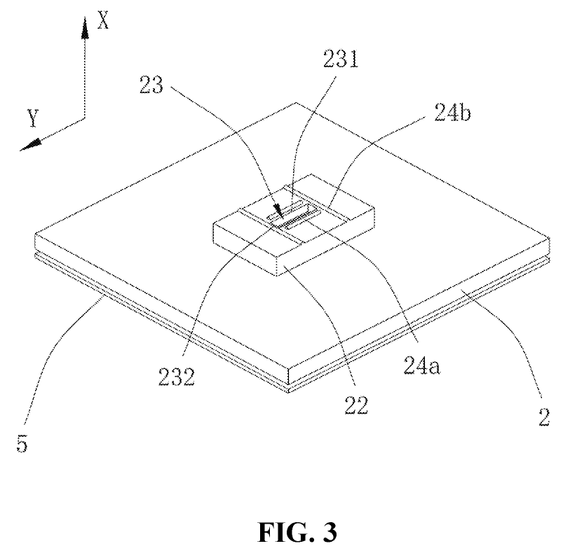

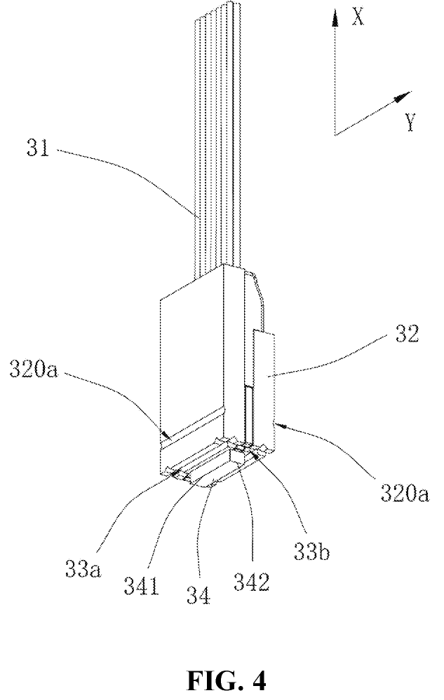

As shown in FIG. 3, the optical through hole 23 has first long sides 231 and first short sides 232. The first long sides 231 extend along the width direction Y of the fiber array 31. The first short sides 232 are arranged respectively perpendicular to the first long sides 231. There are two transverse ribs 24a and two longitudinal ribs 24b. The two transverse ribs 24a are respectively disposed at outer sides of the first long sides 231 of the optical through hole 23. The two longitudinal ribs 24b are respectively disposed at outer sides of the first short sides 232 of the optical through hole 23. As shown in FIG. 4, the second coupling portion 34 has second long sides 341 and second short sides 342. The second long sides 341 extend along the width direction Y of the fiber array 31. The second short sides 342 are arranged respectively perpendicular to the second long sides 341. There are two transverse grooves 33a and two longitudinal grooves 33b. The two transverse grooves 33a are respectively disposed at outer sides of the second long sides 341 of the second coupling portion 34. The two longitudinal grooves 33b are respectively disposed at outer sides of the second short sides 342 of the second coupling portion 34.

As a further preferred solution, the transverse ribs 24a are respectively spaced apart from the longitudinal ribs 24b, preventing potential interference with the positioning fit that could be caused by overlapped portions between the transverse ribs 24a and the longitudinal ribs 24b. The transverse grooves 33a are respectively intersect with the longitudinal grooves 33b. The transverse ribs 24a and the longitudinal ribs 24b each have an arc-shaped cross-sectional profile, and the transverse grooves 33a and the longitudinal grooves 33b each have a V-shaped cross-sectional profile. A fitted design between the arc-shaped ribs and the V-shaped grooves enables precise positioning within a horizontal plane.

To meet different application requirements, in other embodiments, the first alignment structure is a groove structure, and accordingly, the second alignment structure is a protrusion structure. By interchanging the concave and convex designs of the first alignment structure and the second alignment structure, high-precision positioning between the first coupling portion and the second coupling portion within the radial plane of the optical through hole may also be achieved.

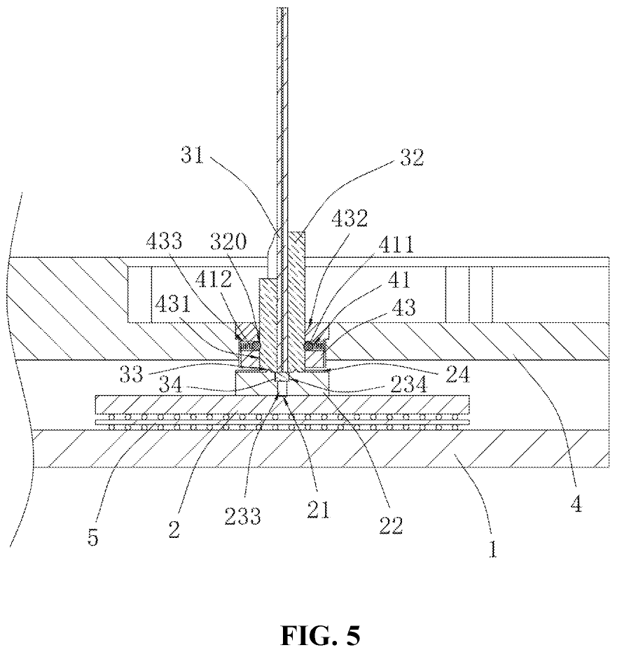

In the present embodiment, as shown in FIGS. 3 and 5, the optical through hole 23 includes a first hole segment 233 and a second hole segment 234 sequentially provided along the axial direction X of the optical through hole 23. The second hole segment 234 is located on a side of the first hole segment 233 away from the silicon photonics chip 2. A cross-sectional width of the first hole segment 233 is less than a cross-sectional width of the second hole segment 234. The second coupling portion 34 is in an accommodating fit with the second hole segment 234, i.e., the second hole segment 234 can allow the second coupling portion 34 to enter, and a fit between the second hole segment 234 and the second coupling portion 34 is not limited to a clearance fit or an interference fit. Through a positioning relationship between the first alignment structure 24 and the second alignment structure 33, and the accommodating fit between the second coupling portion 34 and the second hole segment 234, a positioning effect of two fit structures is achieved, effectively improving positional accuracy of the second coupling portion 34. Herein, the first coupling portion 21 is a microlens embedded in the silicon photonics chip 2. The microlens optically communicates with a waveguide and is mainly configured to focus an optical signal and adjust a direction of the optical signal to ensure a transmission quality of the optical signal. Accordingly, the second coupling portion 34 is a lens, and also configured to focus the optical signal and adjust the direction of the optical signal.

Additionally, the optical engine packaging structure further includes an electrical chip 5 and an application-specific integrated circuit (ASIC) chip 6. The electrical chip 5 and the ASIC chip 6 are respectively flip-chip disposed on the top side of the substrate 1. The electrical chip 5 and the ASIC chip 6 are spaced apart. The silicon photonics chip 2 is flip-chip disposed on a top side of the electrical chip 5. The substrate 1 is electrically connected to the electrical chip 5 and the ASIC chip 6, thereby ensuring functions of optical/electrical signal processing and data computing.

The foregoing are merely preferred embodiments of the present disclosure. It should be noted that several improvements and replacements can be made by a person of ordinary skill in the art without departing from the technical principle of the present disclosure, and these improvements and replacements should also be deemed as falling within the protection scope of the present disclosure.

1. A pluggable optical engine packaging structure, comprising a substrate, a silicon photonics chip, a fiber array unit, and a top cover, wherein the silicon photonics chip is disposed at a top side of the substrate, and the substrate is electrically connected to the silicon photonics chip;
a top side of the silicon photonics chip is provided with a first coupling portion and a positioning seat; the positioning seat is provided with an optical through hole that vertically penetrates through the positioning seat; and the optical through hole corresponds to the first coupling portion;
the fiber array unit comprises a fiber array and a fixing structure; the fixing structure is fixedly connected to the fiber array; a bottom side of the fixing structure is provided with a second coupling portion; and the second coupling portion optically communicates with the fiber array;
the top cover is disposed at the top side of the substrate; the top cover is provided with an insertion hole corresponding to the positioning seat; the insertion hole is coaxially arranged with the optical through hole; and the fixing structure is guided and inserted into the insertion hole;
a top side of the positioning seat is provided with a first alignment structure; the bottom side of the fixing structure is provided with a second alignment structure; the second alignment structure is in a positioning fit with the first alignment structure within a radial plane of the optical through hole; and the second coupling portion is in vertical alignment with the first coupling portion; and
an elastic restricting member is provided inside the insertion hole; the elastic restricting member has a locked state and an unlocked state; an outer side of the fixing structure is provided with an engaging portion; and in the locked state, the elastic restricting member is in a retaining fit with the engaging portion along an axial direction of the optical through hole.

2. The pluggable optical engine packaging structure according to claim 1, wherein the top cover is provided with a fixing hole, a guide sleeve is provided in the fixing hole, the guide sleeve is provided with an inner hole and a tapered countersink hole sequentially arranged along the axial direction of the optical through hole, the tapered countersink hole is located on a side of the inner hole away from the positioning seat, and the inner hole and the tapered countersink hole are connected to form the insertion hole.

3. The pluggable optical engine packaging structure according to claim 2, wherein a side wall of the guide sleeve parallel to a width direction of the fiber array is provided with a horizontal hole, the elastic restricting member is disposed in the horizontal hole; the elastic restricting member comprises a glass ball and a spring, the glass ball is movably disposed in the horizontal hole, the spring is disposed in the horizontal hole, and the spring is in an elastic pressing fit with the glass ball; and the engaging portion is designed as an engaging groove, the engaging groove extends parallel to the width direction of the fiber array, and the engaging groove is in a concave-convex fit with the glass ball.

4. The pluggable optical engine packaging structure according to claim 2, wherein two elastic restricting members are symmetrically provided about the insertion hole, two engaging portions are symmetrically provided about the fixing structure, and a resultant force exerted by the two elastic restricting members on the fixing structure is zero.

5. The pluggable optical engine packaging structure according to claim 3, wherein two elastic restricting members are symmetrically provided about the insertion hole, two engaging portions are symmetrically provided about the fixing structure, and a resultant force exerted by the two elastic restricting members on the fixing structure is zero.

6. The pluggable optical engine packaging structure according to claim 1, wherein the first alignment structure is a protrusion structure, and the second alignment structure is a groove structure; or the first alignment structure is a groove structure, and the second alignment structure is a protrusion structure.

7. The pluggable optical engine packaging structure according to claim 2, wherein the first alignment structure is a protrusion structure, and the second alignment structure is a groove structure; or the first alignment structure is a groove structure, and the second alignment structure is a protrusion structure.

8. The pluggable optical engine packaging structure according to claim 3, wherein the first alignment structure is a protrusion structure, and the second alignment structure is a groove structure; or the first alignment structure is a groove structure, and the second alignment structure is a protrusion structure.

9. The pluggable optical engine packaging structure according to claim 1, wherein the first alignment structure comprises transverse ribs and longitudinal ribs; the transverse ribs extend parallel to a width direction of the fiber array; and the longitudinal ribs are respectively arranged perpendicular to the transverse ribs within the radial plane of the optical through hole;
the second alignment structure comprises transverse grooves and longitudinal grooves; the transverse grooves extend parallel to the width direction of the fiber array; and the longitudinal grooves are arranged respectively perpendicular to the transverse grooves within the radial plane of the optical through hole; and
the transverse ribs are in a concave-convex fit with the transverse grooves, and the longitudinal ribs are in the concave-convex fit with the longitudinal grooves.

10. The pluggable optical engine packaging structure according to claim 9, wherein the optical through hole has first long sides and first short sides; the first long sides extend along the width direction of the fiber array; the first short sides are respectively arranged perpendicular to the first long sides; there are two transverse ribs and two longitudinal ribs; the two transverse ribs are respectively disposed at outer sides of the first long sides of the optical through hole; and the two longitudinal ribs are respectively disposed at outer sides of the first short sides of the optical through hole; and
the second coupling portion has second long sides and second short sides; the second long sides extend along the width direction of the fiber array; the second short sides are respectively arranged perpendicular to the second long sides; there are two transverse grooves and two longitudinal grooves; the two transverse grooves are respectively disposed at outer sides of the second long sides of the second coupling portion; and the two longitudinal grooves are respectively disposed at outer sides of the second short sides of the second coupling portion.

11. The pluggable optical engine packaging structure according to claim 9, wherein the transverse ribs are respectively spaced apart from the longitudinal ribs, and the transverse grooves respectively intersect with the longitudinal grooves.

12. The pluggable optical engine packaging structure according to claim 10, wherein the transverse ribs are respectively spaced apart from the longitudinal ribs, and the transverse grooves respectively intersect with the longitudinal grooves.

13. The pluggable optical engine packaging structure according to claim 9, wherein the transverse ribs and the longitudinal ribs each have an arc-shaped cross-sectional profile, and the transverse grooves and the longitudinal grooves each have a V-shaped cross-sectional profile.

14. The pluggable optical engine packaging structure according to claim 10, wherein the transverse ribs and the longitudinal ribs each have an arc-shaped cross-sectional profile, and the transverse grooves and the longitudinal grooves each have a V-shaped cross-sectional profile.

15. The pluggable optical engine packaging structure according to claim 1, wherein the optical through hole comprises a first hole segment and a second hole segment sequentially provided along the axial direction of the optical through hole; the second hole segment is located on a side of the first hole segment away from the silicon photonics chip; a cross-sectional width of the first hole segment is less than a cross-sectional width of the second hole segment; and the second coupling portion is in an accommodating fit with the second hole segment.

16. The pluggable optical engine packaging structure according to claim 2, wherein the optical through hole comprises a first hole segment and a second hole segment sequentially provided along the axial direction of the optical through hole; the second hole segment is located on a side of the first hole segment away from the silicon photonics chip; a cross-sectional width of the first hole segment is less than a cross-sectional width of the second hole segment; and the second coupling portion is in an accommodating fit with the second hole segment.

17. The pluggable optical engine packaging structure according to claim 3, wherein the optical through hole comprises a first hole segment and a second hole segment sequentially provided along the axial direction of the optical through hole; the second hole segment is located on a side of the first hole segment away from the silicon photonics chip; a cross-sectional width of the first hole segment is less than a cross-sectional width of the second hole segment; and the second coupling portion is in an accommodating fit with the second hole segment.
